(19) United States
(12) Patent Application Publication
(10) Pub. No.: US 2009/0211124 A1
(43) Pub. Date: Aug. 27, 2009

(54) METHOD AND KIT FOR DISPLAY OF MEMORABILIA AND CHARM DISPLAY

(76) Inventor: Nancy Horkey, Montgomery, TX (US)

Correspondence Address: JAMES D. PETRUZZI, 4900 WOODWAY SUITE 745, HOUSTON, TX, 77056, US

(21) Appl. No.: 12/435,907

(22) Filed: May 5, 2009

Related U.S. Application Data
(63) Continuation-in-part of application No. 12/150,919, filed on May 1, 2008.
(60) Provisional application No. 60/927,339, filed on May 3, 2007.

(51) Int. Cl. A47F 7/02; G06Q 90/00; A47F 7/14

(52) U.S. Cl. 40/1; 705/500

(57) ABSTRACT

A kit and method for displaying a plurality of three dimensional members representative of an event on a tree shaped upright display stand where the members are mementos or other ephemera associated with an event such as a birthday, a funeral, a holiday; a graduation; a confirmation; a wedding; a birth; a baby's first event; an annual occurrence; a quinceanera; a Sweet sixteen party; a Wedding anniversary; Combinations thereof. The kit or method may also include a card; a receipt card; a retail picture frame; a small picture frame; a birthday card; a ribbon; a jewel; a crystal; and Combinations thereof.

### CROSS REFERENCE TO RELATED APPLICATIONS

This application is a continuation in part of pending application Ser. No. 12/150,919 entitled Memorabilia and Charm Display which was based on provisional application Ser. No. 60/927,339 filed on May 3, 2007 which is incorporated as if fully set forth herein.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The present invention relates generally to display methods, and in a particular to a method of displaying on a tree shaped or other pre-determined shaped display charms, keepsakes, trinkets and other mementos relating to an individual, family or group affixed for safekeeping or display.

There are a variety of prior art systems for display of photos, charms, keepsakes, trinkets and mementos. Many involve three dimensional stands that are bulky and difficult to package and require large boxes for shipping. Others are instable or use flexible members with clips for holding items. No prior art systems are in place to make a two planar part stand that when assembled creates a multiplicity of display locations for charms, keepsakes, trinkets and other mementos as in the present invention.

### BRIEF SUMMARY OF THE INVENTION

The primary advantage of the invention is to provide an improved method for display of charms, keepsakes, trinkets and other mementos.

Another advantage of the invention is to provide a unique and fanciful structure for display of charms, keepsakes, trinkets and other mementos.

Yet another advantage of the invention is the ability to lay flat the structure when disassembled to facilitate shipping.

A further advantage of the invention is to provide an easy to assemble but sturdy stand.

Another advantage of the invention is to provide a pleasing configuration-in the shape of a tree or other pre-determined shape to denote the collections of one's life.

Another advantage of the invention is to provide a method for collecting and displaying three dimensional objects representative of an event in one's life.

Another advantage of the invention is to provide a method for displaying three dimensional objects that do not fit convention planar scrapbook modalities.

In accordance with a preferred embodiment of the invention, there is shown a display having a first substantially planar member formed of substantially two mirror image sections each having a plurality of extensions for holding items, where the first member has an extended u-shaped void along its longitudinal axis for engaging a reciprocal U shaped void along a longitudinal axis of a second member, and the second substantially planar member has a plurality of extensions for holding items where the two planar members are engaged along the U-shaped voids to form in cross section a substantially X-shaped structure.

In accordance with another preferred embodiment of the invention, there is shown a display having a first substantially flat member formed of substantially two symmetrical sections each having a plurality of extensions for holding items, the first member having an extended rectangular-shaped void along its longitudinal axis for engaging a reciprocal rectangular shaped void along a longitudinal axis of a second member, the second substantially flat member has a plurality of extensions for holding items; the second flat member has a plurality of extensions for holding items, wherein the two flat members when engaged along said rectangular shaped voids form in cross section a substantially X-shaped structure.

In accordance with a preferred embodiment of the invention, there is shown a display having a first substantially flat member formed of two substantially symmetrical sections about a longitudinal axis having a U-shaped void in said axis, the symmetrical sections each having a plurality of extensions for holding items of significance to the user, a second member having a U-shaped void along its axis and at least two legs extended outward from said axis, where the second member is engaged to the first member along said U-shaped void.

In accordance with a preferred embodiment of the invention, there is shown a kit for displaying a plurality of three dimensional members representative of an event having a first planar member formed of two substantially mirror image sections having a plurality of extensions; and at least one additional planar member, which when coupled about the first non-planar member establishes an upright; wherein the upright includes a plurality of extensions for coupling of the at least one member.

In accordance with a preferred embodiment of the invention, there is shown a method of marketing a kit comprised of at least two planar members for displaying at least one three dimensional memento, the steps including targeting an audience based upon a celebratory event; promoting the kit to the audience of the celebratory event; providing the at least memento to the audience representative of the event; and displaying the at least one memento about the at least two planar members.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows an elevation view of the top mating half of a preferred embodiment of the invention.

FIG. 2 shows an elevation view of the bottom mating half of a preferred embodiment of the invention.

FIG. 3 shows a perspective view of a top mating half and bottom mated half of the structure with assembly direction of a preferred embodiment of the invention.

FIG. 4 shows a perspective view of an assembled structure of a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

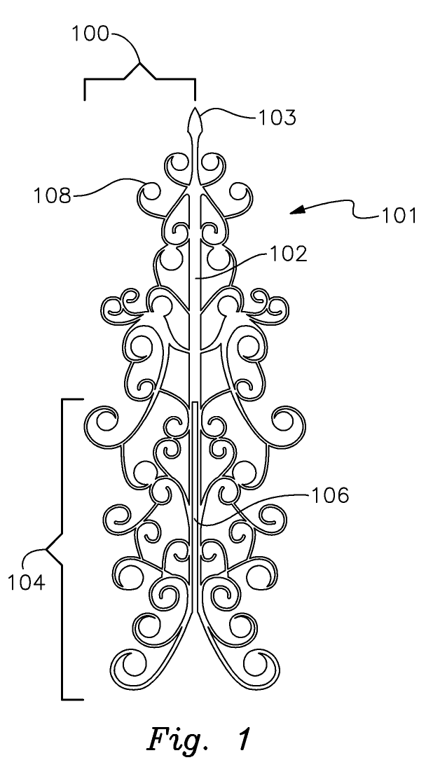

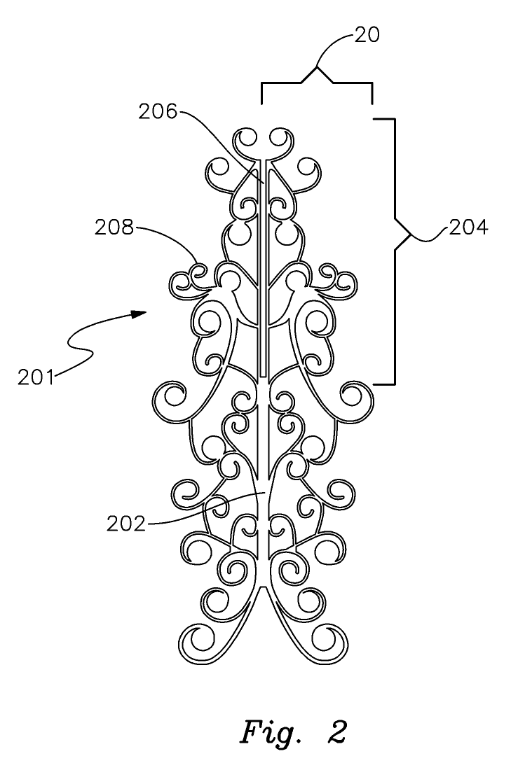

FIG. 1 shows a top mating half of the structure comprising a substantially planar member 101 formed of two substantially mirror image sides 100 co-joined along longitudinal axis spine 102. Planar member 101 has lower portion 104 with a substantially U shaped void or notch 106 within longitudinal axis spine 102. Void 106 functions as a reciprocal mating device for attachment and engagement with a similar void on a bottom mating portion of the structure described below in FIG. 2.

A plurality of generally curved extensions 108 attach to the longitudinal axis spine 102, or lower portion 104, or other extensions off of spine 102 and each other. The extensions are for hanging, suspending or clipping items, charms and mementos of the user. As can readily be seen, the extensions can be of any of a variety of shapes or designs and still achieve the purpose of providing locations for hanging or supporting items. In a preferred embodiment, the structure of the extensions may be configured so. that when fully assembled the stand resembles a tree or any of a variety of pre-determined shapes.

FIG. 2 shows a bottom mating half of the structure comprising a substantially planar second member 201 formed of two substantially mirror image sides 200 cojoined along the longitudinal axis spine 202. The upper portion 204 of longitudinal axis spine 204 has a substantially U-shaped void or notch 206 within longitudinal axis spine 202. Void 206 functions as the mating area for attachment and engagement with the top mating half of the structure described above in FIG. 1. A plurality of generally curved extensions 208 are connected to longitudinal axis spine 202, upper portion 204 or other extensions off of spine 202 for holding or suspending items.

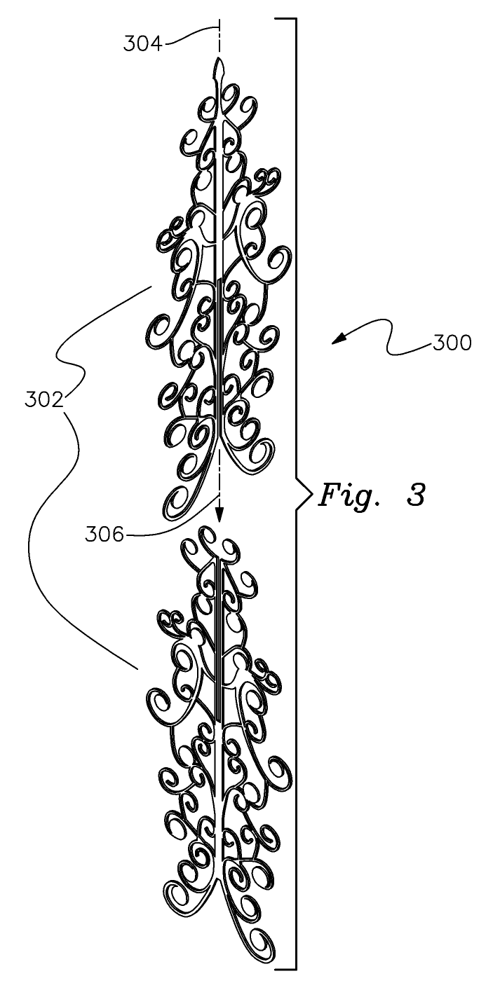

FIG. 3 shows the two-part structure 300 where mating is accomplished along direction 306 at an approximate 90 degree angle between two halves 302 of the structure that engage along longitudinal axis 304. Two halves 302 interlock along voids in each half such that the assembled parts form a unified structure with supporting bases formed by several extensions or other protruding legs. As can readily be understood, the mating or reciprocal U-shaped point of connection may be substantially equal in dimension such that each U-shaped void when joined result in each planar member sitting firmly on the bottom portions of the planar members when in an upright position. However, the U-shaped voids may also be of differing longitudinal dimensions so long as the U-shaped void in the second member and U-shaped void in the first member are substantially equal in summed length to the height of the spine. In alternative embodiments, it my be desirable to have the U-shaped voids of a different summed length so long as the resulting structure can be supported stably on a surface.

In alternative embodiments, planar members 302 may be made of wood, plastic or of a metal frame and configured into the approximate shape of a tree or other pre-determined shape and be coated with a reflective coating with hooks or other fasteners provided so that mementos such as charms, medals, lockets, etc., can be affixed.

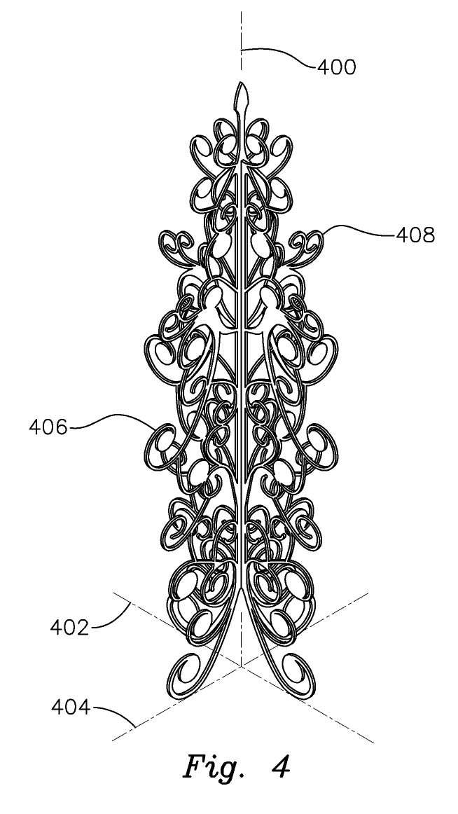

FIG. 4 shows the completed structure mated along longitudinal or z axis 400 as the two halves of the structure form in cross section substantially a cross section X- or cross shape along y axis 402 and x axis 404. The bottom of each half of the structure has two lower extensions which act as a base to allow upright display of the structure. A plurality of generally curved extensions 408 attach to the longitudinal axis spine 402 or other extensions off of the spine 402. In a preferred embodiment some extensions have a solid generally round end 406. In alternative embodiments, the solid end 406 may be affixed with decorative items such as crystal, insignias, mirrors or any of a variety of decorations. Further, the end 406 may be configured in a open manner to receive placement of glass, crystal, mirrors or other decorative adornments, or have clips for attachment.

In an alternative embodiment, planar second member 201 may also be formed by a longitudinal axis spine with a U-shaped void and two legs that extend outward from said spine without having mirror image extensions or any extensions. In this configuration, when the first planar member is joined with its reciprocal void to the void of the second member, the first member acts as a support with extensions for mementos, and the second member creates the cross piece that provides standing support for the assembled structure. In this embodiment, the “tree” appearance is provided by the first planar member, while the second member provides support for the overall structure once assembled.

In a preferred embodiment, a collection of such mementos may be arranged so that they are displayed in the chronological order in which they were acquired, or alternatively, in inverse chronological order of acquisition. The tree structure may also be designed such that extensions 408 more closely resemble the leaves and branches of a tree or other bush or may have leaf shaped end portions as holders. Other embodiments may take on any of a variety of pre-determined shapes.

In yet another embodiment, hooks or fasteners disposed on the tree may be arranged so that larger items can be affixed near the bottom of the structure and smaller items can be affixed near the top in order to maintain an apparent symmetry of the hung charms relative to the fan-like shape of the tree. In still other embodiments, the charm hooks are arranged in an essentially random manner so that mementos of different sizes can be arranged in a more dispersed presentation and in still further embodiments, the hooks or fasteners are themselves detachable, and can be moved or arranged as desired by the stylist of the design. It is also contemplated that the hooks or fasteners can be affixed to the memento or charm prior to hanging, with the combined structure then being affixed to the tree-shaped stand.

According to other aspects of the invention, a reflective coating can be replaced with another type of coating, for example, a flat or non-reflective coating, and in other embodiments, the coating comprises different colors arranged in either a predetermined or user-variable configuration.

In still further embodiments, the frame of the stand is wrapped in cloth or tissue, or a conforming wrap of suitable durability capable of admitting to the displays described above. In further embodiments, the structure has an ornamental terminating part or finial as receiving member disposed for receiving a focal member at or near the top of the tree, much as Christmas and other seasonal trees have receiving members for centerpieces and other focal ornaments.

While the mementos considered for use in connection herewith are described above as “charms, medals, lockets” and the like, virtually any memento capable of fixation to the tree-like structure without causing undue stress or deformation thereof will be suitable for practice within the scope of this disclosure.

The innovative method of the present invention involves the marketing and promotion of a display for typically non-planar objects on a stand that cannot be placed in a normal scrapbook or other book form because the items or mementos are three-dimensional. Further, a group of items that are non-planar are hung on a display for all to be viewed at once, rather than incorporated into a booklet form which involves the flipping of pages in a book style. When the mementos pertain to an event to be remembered, such as a bridal shower, baby shower, Sweet Sixteenth Birthday, Twenty-Fifth wedding anniversary, graduation, etc. it may involve disparate forms of mementos including charms, photos, flowers, jewelry and other non-planar items. In addition, the display may contain a special collection of items such angels or crosses or medals won for performance or service with medals and ribbons for recognition of ones duties.

To display such items in an attractive manner where the individual items are substantially visible to the viewer at one glance, requires a multi-tiered tree with numerous points of attachment and use of that tree to organize the mementos in some desired order.

Typical two dimensional scrapbooking involves preserving personal and family history in the form of photographs, printed media, and memorabilia contained in decorated albums, or scrapbooks. The. idea of keeping printed materials of personal interest probably dates to shortly after the invention of printing. This trend is probably similar for photographs.

The steps of the method involved in the present invention include, selecting a group of non-planar items for display, placing the items on the individual holders or hooks on a three dimensional display stand, typically vertically mounted with a plurality of display locations. The items are arranged on the display in an attractive and desired manner for the display of all of the items without significant overlap of one item over the other.

The display stand has the ability to bring one's collected items out from storage or the closet and preserve the collection in a visible and displayed manner. Prior art systems for scrapbooking cannot hold physical objects like an heirloom watch, a necklace, a pet collar, camp fire badges or other items. Many times these items are kept stored in a drawer or closet often forgotten. By displaying the items on a display, every item or picture or memento is there to see at one time thus turning a two dimensional story into a three dimensional story of the family or event.

The method of the present invention may be utilized in an endless variety of ways including a baby's first tree, a graduation tree, a sweet sixteen party, a quinceanera, first communion, confirmation, weddings, holidays or other memorable events. Further, the display may be used for a memorial to a loved one or at a funeral to display items of noted pertaining to the deceased.

By using a tree stand with numerous points of attachment and organizing display items, one may create a unique method for displaying their items. This method also permits the marketing of numerous ancillary items that may be used in the display method, including, pre-designed cards, small picture frames, note cards, receipt cards, sacks for hanging on the tree, tree skirts, retail picture frames, birthday cards, bows and ribbons, jewels and crystals and other unique finishes to the tree itself.

The foregoing specification is provided for illustrative purposes only, and is not intended to describe all possible aspects of the present invention. Moreover, while the invention has been described in detail with respect to several exemplary embodiments, those of ordinary skill in the pertinent arts will appreciate that minor changes to the description, and various other modifications, omissions and additions may also be made without departing from either the spirit or scope thereof.

While the invention has been described in connection with several preferred embodiments, it is not intended to limit the scope of the invention to the particular form set forth, but on the contrary, it is intended to cover such alternatives, modifications, and equivalents as may be included within the spirit and scope of the invention as defined by the claims.

What is claimed is:

1. A kit for displaying a plurality of three dimensional members representative of an event comprising:
A first planar member formed of two substantially mirror image sections having a plurality of extensions; and
At least one additional planar member, which when coupled about said first non-planar member establishes an upright;
Wherein said upright includes a plurality of extensions for coupling of said at least one member.

2. The kit of claim 1 wherein said at least one three dimensional member is at least one-three dimensional memento associated with said event.

3. The kit of claim 1, wherein at least one ancillary member is disposed about said upright for providing supplementing the association with of said event.

4. The kit of claim 1 wherein the least one three dimensional member is selected from a group representative of:
A birthday;
A funeral;
A holiday;
A graduation;
A confirmation;
A wedding;
A birth;
A baby's first event;
An annual occurrence
A quinceanera
A Sweet sixteen party;
A Wedding Anniversary; and
Combinations thereof.

5. The kit of claim 3, wherein said ancillary member is selected from the group comprising:
A card;
A receipt card;
A retail picture frame;
A small picture frame;
A birthday card;
A ribbon;
A jewel;
A crystal; and
Combinations thereof.

6. The kit of claim 1, wherein said upright includes two or more tiers.

7. The kit of claim 1, wherein said upright further comprises one or more attachment extensions for coupling said at least one three-dimensional memento.

8. The kit of claim 1, wherein said memento wherein said multi-tiered upright cascades downward in diameter.

9. A method of marketing a kit comprised of at least two planar members for displaying at least one three dimensional memento comprising:
Targeting an audience based upon a celebratory event;
Promoting said kit to said audience of said celebratory event;
Providing said at least memento to said audience representative of said event; and
Displaying said at least one memento about said at least two planar members.

10. The method of claim 9 further comprising allowing said audience to dispose said at least one memento about said at least two planar members.

11. The method of claim 9 wherein the least one three dimensional member is selected from a group representative of:
A birthday;
A funeral;
A holiday;
A graduation;
A confirmation;
A wedding;
A birth;
A baby's first event;
An annual occurrence
A quinceanera
A Sweet sixteen party;
A Wedding Anniversary; and
Combinations thereof.

12. The method of claim 9, wherein said ancillary member is selected from the group comprising:
A card;
A receipt card;
A retail picture frame;
A small picture frame;
A birthday card;
A ribbon;
A jewel;
A crystal; and
Combinations thereof.

13. The method of claim 9, wherein said at least two planar members include two or more tiers.

14. The method of claim 9, wherein said at least two planar further comprise one or more attachment extensions for coupling said at least one three-dimensional memento.

15. The method of claim 9, wherein said at least two planar members cascade in at least one direction.
